(19) United States
(12) Patent Application Publication
(10) Pub. No.: US 2023/0300907 A1
(43) Pub. Date: Sep. 21, 2023

(54) RELAY DEVICE MANAGEMENT BASED ON DATA PRIORITY LEVEL

(71) Applicants: Amit KALHAN, San Diego, CA (US); Henry CHANG, San Diego, CA (US); Masato FUJISHIRO, San Diego, CA (US); Kyocera Corporation, Kyoto (JP)

(72) Inventors: Amit KALHAN, San Diego, CA (US); Henry CHANG, San Diego, CA (US); Masato FUJISHIRO, Yokohama (JP)

(21) Appl. No.: 18/021,521

(22) PCT Filed: Aug. 16, 2021
(86) PCT No.: PCT/US2021/046163

§ 371 Date: Feb. 15, 2023

Related U.S. Application Data
(60) Provisional application No. 63/066,601, filed on Aug. 17, 2020.

(51) Int. Cl. H04W 76/10; H04L 1/1812

(52) U.S. Cl. CPC H04W 76/10; H04L 1/1812; H04W 88/04

(57) ABSTRACT

A relay (UE) receives, from a source UE device, a source transmission comprising destination device data and a relay indicator indicating that the destination device data is to be transmitted to a destination UE device. The relay UE device determines whether other communication data is pending transmission to another UE device over a device-to-device communication link. If other communication data is pending transmission, the relay UE device determines whether a destination data priority level of the destination device data is greater than another data priority level of the other communication data. The destination device data is transmitted to the destination UE device in accordance with the priority levels.

### CLAIM OF PRIORITY

The present application claims the benefit of priority to Provisional Application No. 63/066,601 entitled “Device-to-Device Relaying based on Neighbor List Broadcast”, docket number TPRO 00350 US, filed Aug. 17, 2020, assigned to the assignee hereof and hereby expressly incorporated by reference in its entirety.

### FIELD

This invention generally relates to wireless communications and more particularly to wireless communication links using relay devices.

### CROSS REFERENCE TO RELATED APPLICATIONS

This application is related to patent application Ser. No. ______, entitled “RELAY DEVICE MANAGEMENT USING NEIGHBOR LISTS”, docket number TUTL 00350A PC, and patent application Ser. No. ______, entitled “RELAY DEVICE MANAGEMENT USING NEIGHBOR LISTS WITH LINK QUALITY INDICATION”, docket number TUTL 00350C PC, both filed concurrently with this application and incorporated by reference in their entirety herein.

### BACKGROUND

Many wireless communication systems that employ several base stations that provide wireless service to user equipment (UE) devices enable sidelink communication between two or more UE devices where the UE devices can communicate directly with other UE devices. In addition, one or more UE devices can be used as relay devices between a source UE device and a destination UE device where the relay devices forward data received from the source UE device to the destination UE device. Some conventional systems that facilitate device to device transmissions employ ad hoc networks where wireless devices autonomously select communication resources for transmission. For example, under the current NR V2X (5G NR Rel-16 V2X) Mode 2 communication standard, each vehicle-to-vehicle wireless communication device selects time-slot/frequency sub-band resources autonomously for the data transmissions. Such techniques may be used in time division multiple access (TDMA) schemes as well as other access schemes such as the Orthogonal frequency-division multiple access (OFDMA)-TDMA based 5G NR V2X. In TDMA based Vehicle Ad hoc Networks (VANETs) autonomous selection of time-slots for data transmissions causes collisions if two or more devices select the same time-slot for their transmission. Collisions are reduced by control channel decoding based sensing and/or energy-sensing.

### SUMMARY

A relay (UE) receives, from a source UE device, a source transmission comprising destination device data and a relay indicator indicating that the destination device data is to be transmitted to a destination UE device. The relay UE device determines whether other communication data is pending transmission to another UE device over a device-to-device communication link. If other communication data is pending transmission, the relay UE device determines whether a destination data priority level of the destination device data is greater than another data priority level of the other communication data. The destination device data is transmitted to the destination UE device when no other communication data is pending transmission and at a higher priority when the destination data priority level is greater than the another data priority level. The direct communication data is transmitted to the another UE device at a higher priority when the destination data priority level is not greater than the another data priority level.

### BRIEF DESCRIPTION OF THE DRAWINGS

FIG. 1A is a block diagram of an example of a communication system including a plurality of user equipment (UE) devices and two base stations.

FIG. 1B is a block diagram of the communication system for the example of FIG. 1A after the neighbor list messages have been received at the source UE device.

FIG. 1C is a block diagram of the communication system for an example where a candidate has previously reserved a communication resource.

FIG. 2 is a block diagram of an example of a base station suitable for use as each of the base stations.

FIG. 3 is a block diagram of an example of a UE device suitable for use as each of the UE devices.

FIG. 4A is a message flow diagram for an example where a source UE device selects candidate relay devices based, at least partially, on neighbor lists received from UE devices and the relay UE devices are configured with distance-based HARQ feedback (NACK only) by the source UE device.

FIG. 4B is a message flow diagram for an example where a source UE device selects candidate relay devices based, at least partially, on neighbor lists received from UE devices and the relay UE devices are configured with ACK/NACK HARQ feedback by the source UE device.

FIG. 5 is a flow chart of an example of a method of managing relay transmissions at a candidate relay device.

FIG. 6 is a flow chart of a method of transmitting relay transmissions at a candidate relay device including retransmission.

FIG. 7 is a flow chart of an example of a method of managing relay transmissions at a source UE device.

FIG. 8 is a block diagram of an example of a geographical arrangement of UE devices and a corresponding neighbor list including link quality information associated with the arrangement.

FIG. 9 is block diagram of the system for an example the neighbor lists include communication link quality information.

FIG. 10 is a flow chart of an example of a method, performed at a source UE device, of selecting candidate relay devices based on neighbor lists with ranks.

### DETAILED DESCRIPTION

As discussed above, relay devices relay data and control information between a source UE device and a destination UE device. In conventional systems, the relay devices self-declare the relay functionality and/or the communication network identifies UE devices that can provide relay functionality. For the examples herein, however, the source UE by itself and/or with the assistance of the network identifies candidate relay devices and transmits destination device data and an indicator to at least one candidate relay devices. The indicator indicates that the candidate relay device is to forward the destination device data to the destination device. In some situations, the indicator may also reserve a communication resource for the transmission of the destination device data from the candidate relay device. For at least some of the examples discussed herein, the source UE device selects the candidate relay devices based on neighbor lists provided by UE devices. In at least one example, the neighbor lists include link information to the proximate UE devices in the list where the source UE device selects candidate relay devices based, at least partially, on the link information. The link information may include link quality and information related to link quality such the distance to the proximate device. In some situations, the device identifiers in the neighbor list are each associated with a rank of a plurality of ranks where the rank indicates link information.

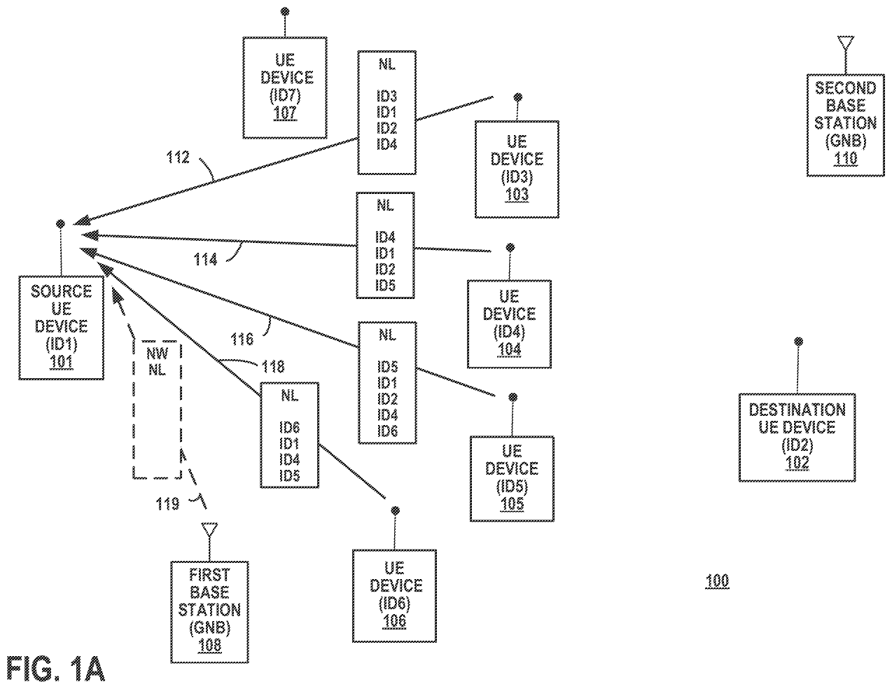

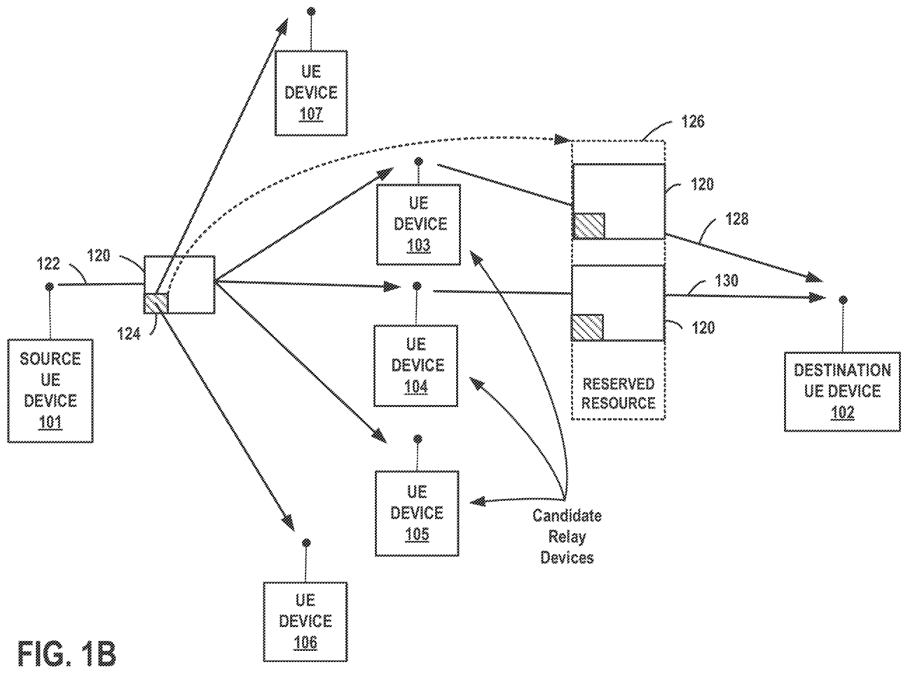

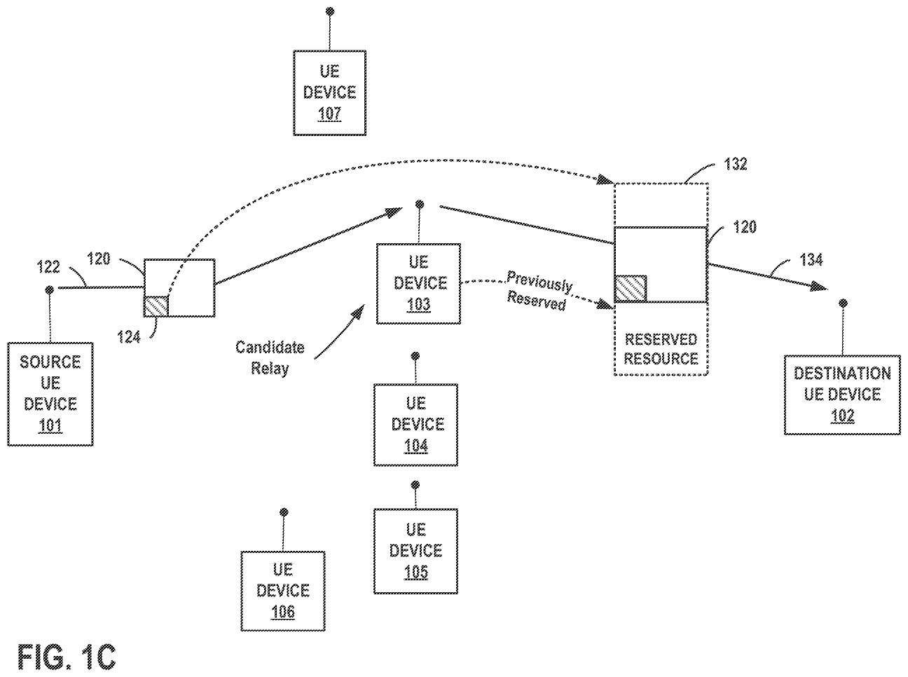

FIG. 1A is a block diagram of an example of a communication system 100 including a plurality of user equipment (UE) devices 101-107 and two base stations 108, 110. Although the techniques discussed herein may be applied to various types of systems and communication specifications, the devices of the example operate in accordance with at least one revision of a 3GPP New Radio (NR) V2X communication specification. The techniques discussed herein, therefore, may be adopted by one or more future revisions of communication specifications although the techniques may be applied to other communication specifications where sidelink or D2D is employed. More specifically the techniques may be applied to current and future releases of 3GPP NR specifications. For example, the techniques may also be applied to 3GPP NR (Rel-17). For the example, the UE devices 101-107 may be any type of device that can receive signals from, and transmit signals to, base stations and other UE devices. The UE devices operate in the communication system that includes a plurality of base stations 108, 110 that each provide wireless service within a service area. For the example of FIG. 1, the UE devices 101-107 may be served by either base station and may transition between base stations in accordance with known handover techniques. Each of the UE devices 101-107, therefore, may be served by a different base station even though two or more UE devices are communicating with each other using a sidelink connection. In some situations, a UE device may be in IDLE mode relative to the base stations when communicating using sidelink.

For the example, a source UE device 101 transmits destination device data to a destination UE device 102 through at least one relay UE device. As discussed in further detail below, the source UE device 101 selects candidate relay devices 103, 104, 105 from nearby UE devices 103-107 based on neighbor list messages 112, 114, 116, 118 received from at least some of the nearby UE devices or from the network. In one scenario, a UE device periodically broadcasts a neighbor list message that includes a list of identifiers (IDs) of proximate UE devices from which the UE device has successfully received a broadcast transmission, such as a discovery message. For the example, a neighbor list includes the device identifiers (IDs) of the UE devices from which the broadcast transmission was successfully received within the previous S time slots where S is a network-wide parameter known to all devices. In some situations where a PC5 connection is established between a UE device and the source UE device, the neighbor list is sent over the unicast link to the source UE device. Therefore, a UE device may notify its neighbor UE devices by broadcast transmissions and/or unicast transmissions. The neighbor list also includes the ID of the UE device transmitting the neighbor list. In situations where half-duplex is used for communication, each UE device broadcasts the neighbor list when no other neighboring device is transmitting using the same resource. In one example, each UE device first finds an unused time-slot and then broadcasts the neighbor list message. After the broadcasted neighbor lists are received, the UE neighboring devices assume the same device will periodically re-broadcast in the same time-slot. For the example of FIG. 1A, the neighbor lists 112, 114, 116 from the UE devices 103-105 include the device identifier (ID2) of the destination UE device 102. The neighbor list 118 broadcasted from the UE device 106, however, does not include ID2. Such as situation may occur, for example, where the signal strength of the broadcast detection signal or neighbor list message transmitted from the UE device 106 is below a minimum threshold. Using the neighbor lists, the source UE device 101 is able to identify all of its immediate neighbors (proximate UE devices) and the immediate neighbors (proximate UE devices) of the immediate neighbors (proximate UE devices). As updated neighbor lists are received, the source UE device updates the maintained information with new additions or removals of the neighboring devices IDs and the neighbor's neighboring devices ID. As discussed herein, “UE device” refers to any UE device, a “potential candidate relay device” refers to a UE device that can be considered by the source UE device to be a candidate relay device, “candidate relay device” is a UE device that has been selected by the source UE device to perform functions as a relay between the source UE device and the destination device, and “relay UE device” is a UE device that at least attempts to perform a relay function. A proximate UE device is a neighbor device to a UE device generating a neighbor list that includes that neighbor device in the neighbor list. Therefore, any specific UE device may be referred to by different terms depending on the stage of the relay device selection and transmission processes and neighbor list generation and transmission processes.

As discussed herein, a neighbor list transmission also includes a transmission that includes sensing data that has been gathered by a UE device and then provided to nearby UE devices where the transmission can be in response to a request from a nearby UE device. For example, each UE device may “sense” their neighbors using energy-detection and/or control information decoding and then broadcast the results and/or directly provide the results to a requesting UE device in response to the request from the requesting UE device.

In some situations, a neighbor list, or at least some information related to a neighbor list, is provided to a UE device, such as the source UE device, by the network. In one scenario, the network maintains location information of each UE device and creates a neighbor list for a particular UE based on the location information. The network then forwards the neighbor list to the UE device through a transmission from a base station. A network generated neighbor list 119 is illustrated in FIG. 1A with dashed lines to indicate that the neighbor list 119 is optional. In another scenario, the network periodically broadcasts a list of UE devices detected within the region to all the UE device located in the same region. In one example, the network neighbor list 119 includes a list of neighbor UE devices to the source UE device and the neighbor UE devices to each of the UE devices listed in the neighbor list. Accordingly, the source UE device can determine which of its neighbors has the destination UE device as a neighbor from such a neighbor list. In another example, the network neighbor list identifies possible relay candidate devices and the source UE device requests neighbor lists from these possible relay candidate devices. In such an example, the network may identify the appropriate possible relay candidate devices in response to a request from the source UE device. After receiving the neighbor lists from the possible candidate relay device, the source identifies those that include the destination device as a neighbor and selects the candidate relay device(s).

FIG. 1B is a block diagram of the communication system 100 for the example of FIG. 1A after the neighbor list messages 112, 114, 116, 118 have been received at the source UE device 101. The source UE device 101 evaluates the information provided by the neighbor list messages 112, 114, 116, 118 and selects candidate relay devices. For the example of FIG. 1A and FIG. 1B, the source UE device selects three UE devices 103, 104, 105 as the candidate relay devices. Since the three neighbor list messages 112, 114, 116 transmitted from the three UE devices 103, 104, 105 included the ID of the destination device (ID2), the source UE device determines that the three base stations 103, 104, 105 are suitable candidates for relaying (forwarding) the destination device data 120 to the destination UE device 102. As discussed below, additional criteria may be used by the source UE device 101 in selecting the candidate relay devices. In some situations, for example, information related to the proximity of the destination UE device to each UE device may be provided in the neighbor list where the source UE device selects the candidate relay devices based on the proximity. Other criteria can also be evaluated.

The source UE device transmits a transmission 122 including the destination device data 120 and control information 124. The destination device data 120 is the data that the source UE device intends to be delivered to the destination UE device 102. The control information 124 includes at least a relay indicator that indicates to each candidate relay device that it is to relay the destination device data 120 to the destination UE device. In some situations, the transmission 122 comprises multiple transmissions. For example, at least some of the control information 124 may be transmitted in a transmission other than the transmission including the destination device data. The relay indicator may be conveyed to a candidate relay device during the establishment of the unicast (PC5) connection which is prior to the transmission of the destination device data. The relay indicator may be transmitted in the Direct Communication Request message (PC5-S) that initiates the unicast link establishment procedure. The relay indicator at least includes the ID of the destination UE device and may include some information indicating the candidate relay device should transmit the destination device data to the destination UE device. The relay indicator may be implicit in some circumstances. An example of suitable technique for transmitting the relay indicator includes techniques used in convention systems except that the relay indicator indicates to the candidate relay device that it has been selected to be a relay device. An example of suitable technique includes using a 1-bit control field where presence of the flag indicates that the candidate relay device is to relay the destination device data. The indicator may also be implicit. In one scenario, for example, the inclusion of the destination device ID in the source transmission indicates that the destination device data is to be relayed. The existence of the destination UE device ID in a received transmission at the candidate relay device, therefore, may form the relay indicator in some situations.

In some situations, the control information 124 also includes a communication resource reservation. In examples of such situations, the communication resource reservation and the relay indicator are directed to the candidate relay devices 103, 104, 105 while the communication resource reservation is directed to all near-by UE devices. The near-by UE devices include UE devices that are capable of receiving the control information 124 transmission and may include UE devices that provided neighbor lists but were not selected as a candidate relay device. The nearby devices may also include other UE devices such as devices that recently entered the area near the source UE device and UE devices that did not transmit a neighbor list message. In some situations, for example, a UE device refrains from transmitting a neighbor list message but rather broadcasts a discovery signal or message to all the neighboring devices. Other UE devices receive the broadcast and detect the presence of the broadcasting UE device. The devices interested in becoming a relay device, detect the discovery messages, compile the information in the messages and broadcast a neighbor list message. For the example for FIG. 1B, therefore, the communication resource reservation is directed to UE devices from which a neighbor list was received but also to any other UE device within range of the control signal.

The communication resource reservation reserves a communication resource 126 which may be, for example, one or more timeslots in a particular channel or at a particular frequency. For the example, the communication resource reservation is performed in accordance with techniques for reserving resources defined in the 5G NR V2X Mode-2 communication specification except that the reservation is not for a future transmission from the UE device transmitting the reservation (source UE device) but is rather for one or more other UE devices (relay devices) for transmission to the destination UE device. For example, applying the NR V2X physical layer design, the reservation for the relayed data is transmitted as a part of the 2nd stage sidelink control information (SCI). The 2nd stage SCI consists of the location of the reserved resource, destination device ID, priority and MCS of the relayed transmission if different from the source to relay device transmission. In some situations, the communication resource reservation is omitted. In other situations, the transmission of the communication resource reservation is dynamically determined by the source UE device. In still other situations, the network may dynamically determine when communication resource reservation transmissions are authorized. Where the determination is made dynamically, the determination may be based on current circumstances in the area. In one example, the determination is based, at least partially, on the level of communication traffic or communication congestion in the area where the determination that the communication resource reservation should be transmitted decreases with higher levels of traffic and/or congestion.

After identifying the candidate relay devices, the source UE device determines whether to send the transmission 122 in a broadcast transmission or a unicast transmission. As is known, different transmission techniques often referred to as cast types can be used to transmit the same data to multiple UE devices. Cast types include at least unicast, groupcast and broadcast. A unicast transmission can only be received by the single UE device that is the intended recipient of the data. Accordingly, multiple transmissions are required to send the same data to multiple UE devices using unicast. A broadcast transmission can typically be received by all UE devices within range of the transmission. A groupcast transmission can only be received by the UE devices that are members of a group. For the examples herein, broadcast transmissions to candidate relay devices include UE device identifying information. Although the broadcast can be received by all of the UE devices in the area, the broadcast transmission is directed to the selected relay candidate devices. For at least some of the examples herein, therefore, a candidate relay device determines it has been selected as a candidate relay device based on the identifying information included in the broadcast transmission. An example if suitable identifying information includes the UE ID. Accordingly, for the example, the source UE device 101 can transmit the transmission 122 with the destination device data 120 in a single transmission using broadcast to two or more candidate relay devices in a group or can send the same data in multiple unicast transmissions to the candidate relay devices. For the unicast transmission examples, the unicast connection between the source UE device and each selected candidate relay device is established before the transmission of the destination device data. In the interest of clarity and brevity, FIG. 1B and FIG. 1C show a single arrow and box representing the transmission 122 although the transmission 122 may comprise multiple transmissions in some circumstances. Therefore, the transmission from the source UE device 101 to multiple candidate relay devices may be facilitated by multiple unicast connections or a broadcast connection. In some situations, groupcast connection may be used for the connection between the source UE device and multiple candidate relay devices. Such a technique is different from a groupcast transmission to multiple destination UE devices. For example, a source UE device may use one or more relay devices to relay a groupcast transmission to multiple destination UE devices where the connection between the source UE device and the candidate relay device(s) may be unicast or broadcast.

Each candidate relay device 103-105 receives the transmission 122 and evaluates the control information 124 to determine that the source UE device 101 is requesting the candidate relay device to relay the destination device data 120 to the destination UE device 102. For the example, the candidate relay device identifies the destination UE device 102 based on the identifier (ID2) included in the control information 124. The candidate relay device determines whether to perform the relay function for the source UE device and the destination UE device. In some situations, the determination may be based on availability of resources at the candidate relay device such as memory, battery life, available bandwidth and/or channel conditions. As discussed below, the determination may be based on the relative priorities of data including the destination device data 120, the data for the relay device's own communication, and data for other destination device data included in relay request transmissions from other source UE devices.

If the candidate relay device determines that the destination device data 120 can be relayed, the candidate relay device becomes a relay UE device and transmits the destination device data 120 in a relay transmission to the destination UE device. For the example, two candidate relay devices 103, 104 each send a relay transmission 128, 130 including the destination device data but the third candidate relay device 105 refrains from sending a transmission. For the example, the relay transmissions 128, 130 are the same signal and are transmitted in the reserved communication resource 126. Accordingly, the relay transmissions 128, 130 appear as a single transmitted signal experiencing multipaths at the destination UE device 102 and can be received with conventional receiver components. One or more UE devices may be selected as a candidate relay device and any number of the candidate relay devices become relay UE device. As discussed below, Hybrid Automatic Repeat Request (HARQ) messages are transmitted in response to the transmission 122 and/or the relay transmissions 128, 130 in the examples herein.

FIG. 1C is a block diagram of the communication system 100 for an example where a candidate has previously reserved a communication resource 132. For the example, the source UE device 101 has received the neighbor list messages 112, 114, 116, 118 as discussed with reference to FIG. 1A and has also acquired information identifying communication resources reserved by one or more nearby UE devices 103-107. In some situations, the source UE device 101 acquires the information identifying communication resources reserved by other UE devices based on the broadcasted control signals from the other UE devices. For example, conventional techniques provide a mechanism for a UE device to reserve a future communication resource and the source UE device 101 detects such control signals. As discussed above, examples of communication resource reservation techniques are defined in the 5G NR V2X Mode-2 communication specification. In other situations, a nearby UE device or UE based Road Side Unit (RSU) may function as a scheduler for sidelink communications between UE devices in the area near the scheduling UE device. The scheduling UE device, therefore, reserves communication resources for one or more other UE devices in the area and the source UE device identifies the reserved communication resources based on the scheduling signals received from the scheduling UE device. In some situations, one of the candidate relay devices is a scheduling device where the scheduling device periodically announces the reservation of a set of resources to the neighboring UE devices including the source UE device. In one scenario, the source UE device transmits the source transmission including the destination device data to the candidate relayed device(s) using the resources reserved by the scheduling device. In another scenario, the source UE device 101 transmits the source transmission to the candidate relay device(s) before the time of the reserved resources and one or more candidate relay devices use the resources reserved by the scheduling device to transmit the relay transmission to the destination device.

For the example of FIG. 1C, the source UE device 101 evaluates the neighbor list messages and the reserved communication resources to identify a candidate relay device. In some situations, the source UE device may identify several potential candidate relay devices based on the neighbor lists and reserved resources although only one candidate relay device is selected. The source UE device may apply additional criteria in selecting the candidate relay device. The source UE device, for example, may evaluate the proximity of the potential candidate relay devices to the destination UE device.

The source UE device 101 sends a transmission 122 that includes the destination device data 120 and control information 124 that includes a communication resource preemption indicator. The communication resource preemption indicator indicates to the candidate relay device 103 that the source UE device is requesting that the candidate relay device use the communication resource 132 for transmission of the destination device data where the communication resource 132 had been previously reserved by the candidate relay device 103 (or have been reserved for the candidate relay device by another device such a scheduling UE device). For the example of FIG. 1C, therefore, the source UE device 101 does not transmit a communication resource reservation as discussed with reference to FIG. 1B. In some situations, the source UE device 101 may transmit both a communication resource reservation and a communication resource preemption indicator. In other situations, the source UE device 101 may dynamically make a determination whether to send a communication resource reservation or a communication resource preemption indicator. For example, if the source UE device is transmitting the source transmission via broadcast to multiple candidate relay devices, a communication resource reservation may be transmitted and where the source UE device is transmitting the source transmission via unicast to a candidate relay device, a communication resource preemption indicator may be transmitted.

The candidate relay device 103 receives the transmission 122 and evaluates the control information 124 to determine that the source UE device 101 is requesting the candidate relay device to relay the destination device data 120 to the destination UE device 102 using the communication resource 103 previously reserved by the candidate relay device 103. For the example, the candidate relay device identifies the destination UE device 102 based on the identifier (ID2) included in the control information 124. The candidate relay device 102 determines whether to perform the relay function for the source UE device 101 and the destination UE device 102. In some situations, the determination may be based on availability of resources at the candidate relay device 103 such as memory, battery life, available bandwidth and/or channel conditions. As discussed below, the determination may be based on the relative priorities of data including the destination device data 120, the data for the relay device's own communication, and data for other destination device data included in relay request transmissions from other source UE devices.

If the candidate relay device 103 determines that the destination device data 120 can be relayed, the candidate relay device 103 becomes a relay UE device and transmits the destination device data 120 in a relay transmission 134 to the destination UE device. As discussed below, Hybrid Automatic Repeat Request (HARQ) messages are transmitted in response to the transmission 122 and/or the relay transmissions 128, 130 in the examples herein. In some situations, the determination on whether a candidate relay device may function as a relay UE device depends on the destination UE device. For example, after receiving the source transmission, the candidate relay attempts to establish the R-D communication link where the destination UE device accepts the candidate relay device as a relay UE device. After the establishment of the R-D communication link, the candidate relay device becomes the relay UE device. If the destination UE device does not accept the candidate as a relay, the candidate relay device does not become a relay UE device.

Where multiple candidate relay devices are selected by the source UE device, the destination UE device may select which candidate relay device(s) to accept (with a reply) as a relay UE device according to one or more factors. Examples of factors and criteria for down-selection by the destination UE device include signal strength, link quality, local policy, and combinations thereof. Other criteria may also be used.

As discussed above, the source transmission may be transmitted to one or more candidate relay devices using unicast or broadcast, respectively. In the unicast transmission case, the candidate relay device is selected after the source UE device and the relay UE device establish a unicast link. In a typical scenario, the initial step of the unicast link establishment includes the transmission of the Direct Communication Request message (an application layer message) which includes setting the relay indication field. For the situation where more than one candidate relay device is selected, the source UE device may establish multiple unicast links or a broadcast with relay UE identifying information to the selected candidate relay devices. The unicast link establishment is typically preceded by the discovery protocol including either Model A or Model B discovery, which includes neighbor lists. Establishing the side link (SL) unicast connection or PC5-RRC allows the two UE device to share their capabilities and use common RLC configuration (e.g., RLC-UM or RLC-AM which includes RLC ACK/NACK).

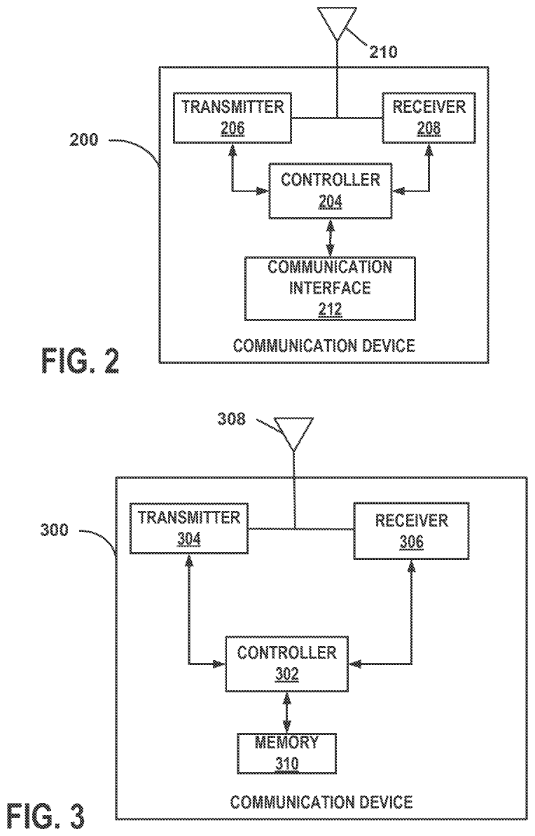

FIG. 2 is a block diagram of an example of a base station 200 suitable for use as each of the base stations 108, 110. The base station 200 includes a controller 204, transmitter 206, and receiver 208, as well as other electronics, hardware, and code. The base station 200 is any fixed, mobile, or portable equipment that performs the functions described herein. The various functions and operations of the blocks described with reference to the base stations 108, 110 may be implemented in any number of devices, circuits, or elements. Two or more of the functional blocks may be integrated in a single device, and the functions described as performed in any single device may be implemented over several devices. The base station 200 may be a fixed device or apparatus that is installed at a particular location at the time of system deployment. Examples of such equipment include fixed base stations or fixed transceiver stations. Although the base station may be referred to by different terms, the base station is typically referred to as a gNodeB or gNB when operating in accordance with one or more communication specifications of the 3GPP V2X operation. In some situations, the base station 200 may be mobile equipment that is temporarily installed at a particular location. Some examples of such equipment include mobile transceiver stations that may include power generating equipment such as electric generators, solar panels, and/or batteries. Larger and heavier versions of such equipment may be transported by trailer. In still other situations, the base station 200 may be a portable device that is not fixed to any particular location.

The controller 204 includes any combination of hardware, software, and/or firmware for executing the functions described herein as well as facilitating the overall functionality of the base station 200. An example of a suitable controller 204 includes code running on a microprocessor or processor arrangement connected to memory. The transmitter 206 includes electronics configured to transmit wireless signals. In some situations, the transmitter 206 may include multiple transmitters. The receiver 208 includes electronics configured to receive wireless signals. In some situations, the receiver 208 may include multiple receivers. The receiver 208 and transmitter 206 receive and transmit signals, respectively, through an antenna 210. The antenna 210 may include separate transmit and receive antennas. In some circumstances, the antenna 210 may include multiple transmit and receive antennas.

The transmitter 206 and receiver 208 in the example of FIG. 2 perform radio frequency (RF) processing including modulation and demodulation. The receiver 208, therefore, may include components such as low noise amplifiers (LNAs) and filters. The transmitter 206 may include filters and amplifiers. Other components may include isolators, matching circuits, and other RF components. These components in combination or cooperation with other components perform the base station functions. The required components may depend on the particular functionality required by the base station.

The transmitter 206 includes a modulator (not shown), and the receiver 208 includes a demodulator (not shown). The modulator modulates the signals to be transmitted as part of the downlink signals and can apply any one of a plurality of modulation orders. The demodulator demodulates any uplink signals received at the base station 200 in accordance with one of a plurality of modulation orders.

The base station 200 includes a communication interface 212 for transmitting and receiving messages with other base stations. The communication interface 212 may be connected to a backhaul or network enabling communication with other base stations. In some situations, the link between base stations may include at least some wireless portions. The communication interface 212, therefore, may include wireless communication functionality and may utilize some of the components of the transmitter 206 and/or receiver 208.

FIG. 3 is a block diagram of an example of a UE device 300 suitable for use as each of the UE devices 101-107, 801-807. In some examples, the UE device 300 is any wireless communication device such as a mobile phone, a transceiver modem, a personal digital assistant (PDA), a tablet, or a smartphone. In other examples, the UE device 300 is a machine type communication (MTC) communication device or Internet-of-Things (IOT) device. The UE device 300, therefore is any fixed, mobile, or portable equipment that performs the functions described herein. The various functions and operations of the blocks described with reference to UE device 300 may be implemented in any number of devices, circuits, or elements. Two or more of the functional blocks may be integrated in a single device, and the functions described as performed in any single device may be implemented over several devices.

The UE device 300 includes at least a controller 302, a transmitter 304 and a receiver 306. The controller 302 includes any combination of hardware, software, and/or firmware for executing the functions described herein as well as facilitating the overall functionality of a communication device. An example of a suitable controller 302 includes code running on a microprocessor or processor arrangement connected to memory. The transmitter 304 includes electronics configured to transmit wireless signals. In some situations, the transmitter 304 may include multiple transmitters. The receiver 306 includes electronics configured to receive wireless signals. In some situations, the receiver 306 may include multiple receivers. The receiver 304 and transmitter 306 receive and transmit signals, respectively, through antenna 308. The antenna 308 may include separate transmit and receive antennas. In some circumstances, the antenna 308 may include multiple transmit and receive antennas.

The transmitter 304 and receiver 306 in the example of FIG. 3 perform radio frequency (RF) processing including modulation and demodulation. The receiver 304, therefore, may include components such as low noise amplifiers (LNAs) and filters. The transmitter 306 may include filters and amplifiers. Other components may include isolators, matching circuits, and other RF components. These components in combination or cooperation with other components perform the communication device functions. The required components may depend on the particular functionality required by the communication device.

The transmitter 306 includes a modulator (not shown), and the receiver 304 includes a demodulator (not shown). The modulator can apply any one of a plurality of modulation orders to modulate the signals to be transmitted as part of the uplink signals. The demodulator demodulates the downlink signals in accordance with one of a plurality of modulation orders.

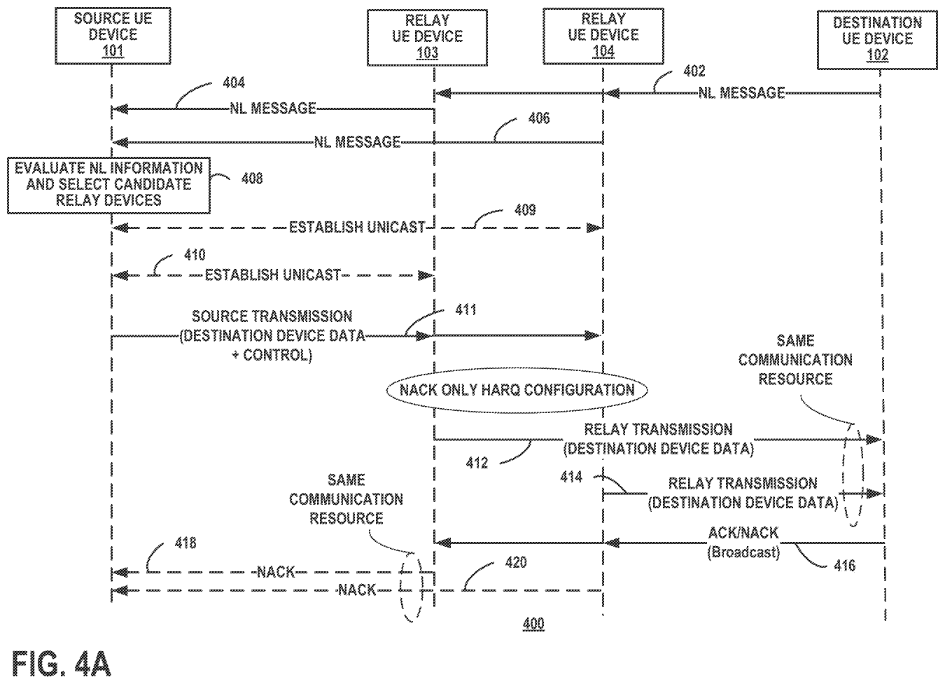

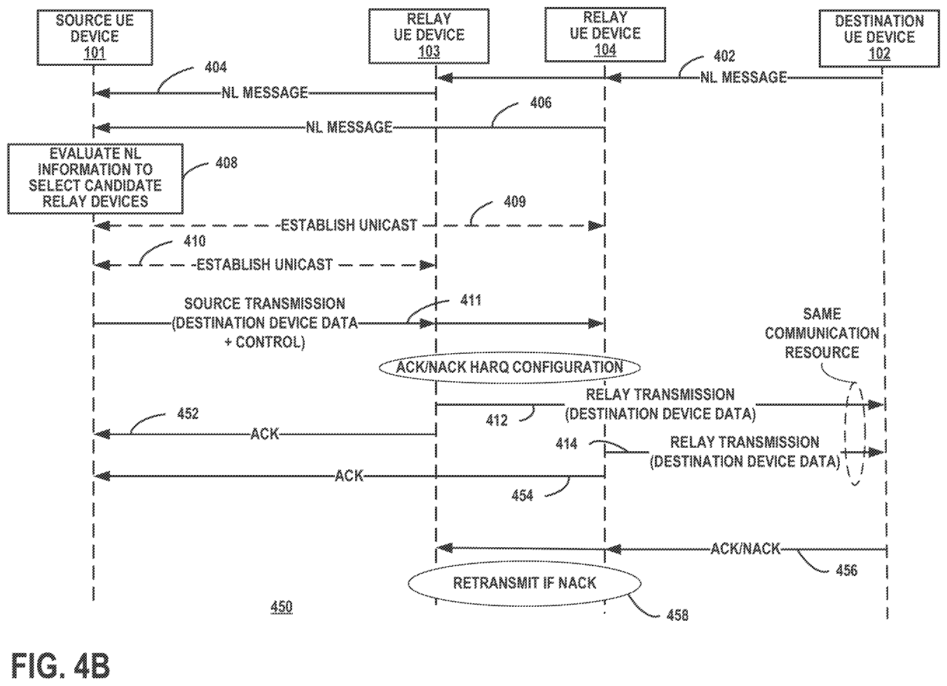

FIG. 4A is a message flow diagram 400 for an example where a source UE device 101 selects candidate relay devices based, at least partially, on neighbor lists received from UE devices and the relay UE devices are configured with distance-based HARQ feedback (NACK only) by the source UE device 101. The message flow of FIG. 4A is one example of a message flow scenario for the communication system 100 discussed above with reference to FIG. 1A, FIG. 1B and FIG. 1C. The destination UE device 102 broadcasts its neighbor list message at transmission 402. Near-by UE devices in communication range of the destination device including the UE devices 103, 104 receive the neighbor list message. In some situations, the destination UE device may broadcast a discovery message rather that the neighbor list message allowing all the neighboring devices to detect the presence of the destination UE device 102.

At transmission 404, the UE device 103 transmits a neighbor list message that includes IDs of the UE devices that the UE device 103 has detected either through received neighbor list messages or discovery messages. The neighbor list message also includes the IDs of the UE devices included in the received neighbor list messages. At transmission 406, the UE device 104 transmits a neighbor list message. Since both of the UE devices 103, 104 received the neighbor list message from the destination UE device 102, the identification (ID2) of the destination UE device 102 is included in the neighbor list messages received by the source UE device 101 in the transmissions 404, 406 from the UE devices 103, 104.

At event 408, the source UE device evaluates the neighbor list messages and selects candidate relay devices. The selection of the candidate relay devices may be based on criteria in addition to the neighbor lists.

As discussed herein, transmissions from the source UE device 101 to multiple candidate relay devices 103, 104 may be over multiple unicast connections or via broadcast. Where unicast is used, the unicast connections are established before the transmission of destination device data. Transmissions 409 and 410 establish the unicast connections with the candidate relay device 104 and candidate relay devices 103, respectively. The arrows representing the transmissions 109, 110 are shown with dashed lines to indicate that the transmissions 109, 110 are omitted where broadcast techniques are used. The transmission 109, 110 convey the relay indicator since the unicast establishment includes information identifying the UE devices 103, 104 as candidate relay devices.

At transmission 411, the source UE device 101 sends destination device data and control information to the candidate relay devices. The transmission 411, therefore, is an example of the source transmission 122 discussed above for a broadcast transmission and transmissions 409, 410, 411 are an example of the source transmission 122 where unicast is used. For a broadcast transmission, the transmission 411 indicates to the candidate relay devices 103, 104 that the candidate relay devices 103, 104 are to relay the destination device data to the destination device. Two relay UE devices 103, 104 are shown in FIG. 4A although the transmission 411 may have been transmitted to additional candidate relay devices such as UE device 105, for example. For the example of FIG. 4A, the transmission 411 may be a broadcast transmission directed to the group consisting of the candidate relay devices where the UE devices 103, 104 are identified in the broadcast transmission. In accordance with known techniques, the source UE device (transmitting UE device) provides a HARQ feedback configuration to the candidate relay devices (receiving UE devices). For the example of FIG. 4A, the HARQ feedback configuration is distance-based HARQ configuration where the receiving devices only transmit NACK feedback when within a maximum distance.

At transmission 412, the relay UE device 103 transmits the destination device data to the destination UE device 102. At transmission 414, the relay UE device 104 transmits the destination device data to the destination UE device 102. For the example, the two transmission are the same and are transmitted using the same communication resource. Accordingly, at the destination UE device 102, the two transmissions 412, 414 resemble a single transmission that has experienced multi-path propagation and, therefore, can be received by the destination UE device 102 using conventional receiving techniques. In one scenario, the relay transmission 412 and the relay transmission 414 are broadcast. In another scenario, the relay transmission 412 and the relay transmission 414 are transmitted over unicast connections. Where unicast is used, the unicast connections are established prior to the transmission of the destination device data in the relay transmissions 412, 414. The destination device data, however, may still be transmitted over the same communication resource by using the same radio bearer for the unicast transmissions of the destination device data.

At transmission 416, HARQ feedback is transmitted from the destination UE device 102. For the example, the HARQ feedback is a broadcast transmission that can be received by all of the relay UE devices 103, 104 that transmitted destination device data. The HARQ feedback may be ACK/NACK or NACK only depending on the HARQ feedback configuration.

At transmission 418, the relay UE device 103 sends HARQ feedback to the source UE device 101. At transmission 420, the relay UE device 104 sends HARQ feedback to the source UE device 101. Since the HARQ configuration established by the source UE device 101 is distance based HARQ, only NACK feedback is provided. Accordingly, the arrows representing the transmissions 418, 420 in FIG. 4A are shown as dashed to indicate the transmissions 418, 420 are performed only when NACK is required. For the example, the same communication resource is used to transmit the NACK feedback to the source UE device. Since the transmission 418 from the relay UE device 403 is the same as the transmission 420 from the relay UE device 404, the signals appear as a single transmission experiencing multipath propagation. The NACK transmissions 418, 420 may be sent in response to a NACK feedback received from the destination UE device 102 or may be in response to failed reception of the transmission 410. In some situations, therefore, only one of the relay UE devices may transmit the NACK feedback to the source UE device 101.

FIG. 4B is a message flow diagram 450 for an example where a source UE device 101 selects candidate relay devices based, at least partially, on neighbor lists received from UE devices and the relay UE devices are configured with ACK/NACK HARQ feedback by the source UE device 101. The message flow of FIG. 4B is one example of a message flow scenario for the communication system 100 discussed above with reference to FIG. 1A, FIG. 1B and FIG. 1C. The transmissions 402, 404, 406, 409, 410, 411, 412, 414 and event 408 are performed as discussed above with reference to FIG. 4A with the exception that the HARQ configuration for HARQ feedback from the candidate relay devices is ACK/NACK and not distance-based HARQ.

At transmission 452, the relay UE device 103 sends an ACK HARQ feedback to inform the source UE device 101 that the source transmission 410 was successfully received by the relay UE device 103. At transmission 454, the relay UE device 104 sends an ACK HARQ feedback to inform the source UE device 101 that the source transmission 410 was successfully received by the relay UE device 104. For the example of FIG. 4B, therefore, the HARQ feedback transmitted from the relay devices is not transmitted over the same communication resource.

At transmission 456, the destination UE device 102 broadcasts HARQ feedback to the relay UE devices 103, 104 indicating whether the relay transmissions 412, 144 were successfully received at the destination UE device 102. Since the relay transmissions are the same, an ACK is transmitted when at least one relay transmission is successfully received. For the example of FIG. 4B, therefore, the HARQ feedback from the relay UE devices to the source UE device 101 is independent from the HARQ feedback form the destination UE device 102 to the relay UE devices 103, 104. In other words, the relay UE devices only provide feedback regarding the signals transmitted to the relay UE devices and do not forward, or otherwise convey, results of the HARQ feedback received from the destination UE device 102 for the example of FIG. 4B.

At event 458, the relay devices perform retransmission is a NACK feedback is received from the destination UE device 102. If a NACK feedback is received, each relay UE device retransmits the destination device data in a relay transmission. In some situations, the relay transmissions from the relay devices use the same communication resources and transmit the same signal. In some case, when the relay devices do not receive either ACK or NACK (i.e., HARQ-DTX), the relay UE devices perform retransmission of the destination device data.

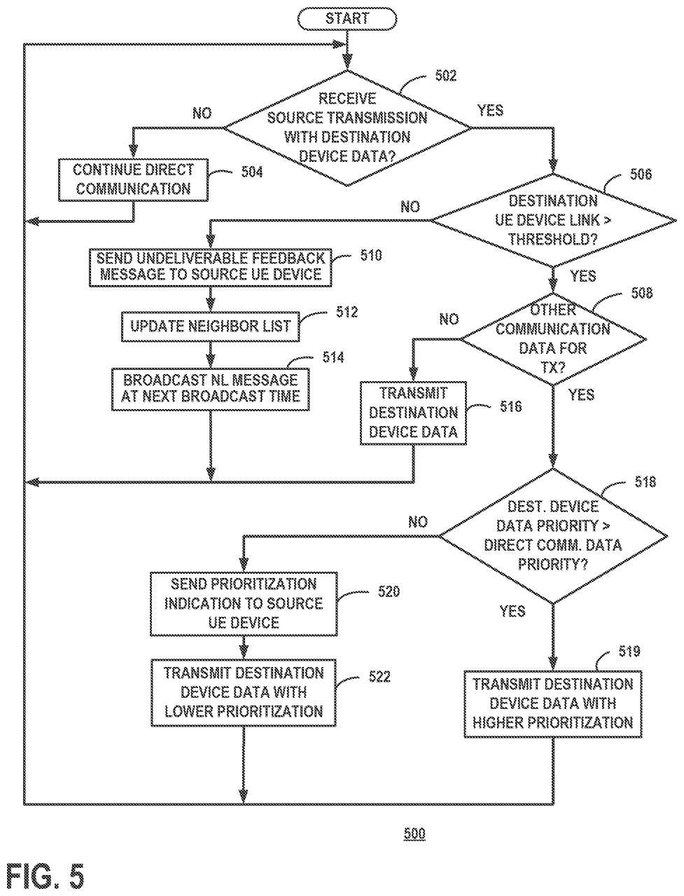

FIG. 5 is a flow chart of an example of a method 500 of managing relay transmissions at a candidate relay device. For the example, the method is performed by a UE device operating in system in accordance with at least one revision of the NR V2X specification, such as the system 100 described above. Accordingly, the method may be performed by the relay UE devices 103-105.

At step 502 it is determined whether a source transmission with destination device data has been received from a source UE device with an indication that the destination device data is to be relayed to a destination UE device. In situations where the source transmission is a broadcast transmission with relay identifying information, the source transmission may include both the destination device data and the relay indicator requesting that the candidate relay device relay the destination device data to the destination device. Where the source transmission is a unicast transmission, the source transmission typically includes destination device data and some identification information that allows the relay UE device to determine that the transmission is directed to relay UE device. Such identification information may include the UE ID of the relay UE device. In another example the identification information includes the UE ID of the destination UE device. Where the identification information does not include the relay UE ID and includes the UE ID of the destination UE device, the identification information may also include the UE ID of the source UE device. Information other than the UE ID may be used in some situations. An example of suitable mechanism for transmitting the identification information includes transmitting the identification information in the Side Control Information (SCI). As discussed above, the relay request indicator is transmitted during the establishment of the PC5-RRC connection such as, for example, in the Direct Communication Request message (PC5-S). Accordingly, the relay request indicator may not be sent with the destination device data in the source transmission in some scenarios. In some other scenarios, however, the relay request indicator may be included in the source transmission and may include enough information to provide the identification information. If no source transmission has been received, the method proceeds to step 504 where the UE device continues with direct UE device to UE device communication and returns to step 502. If a source transmission has been received, the method continues at step 506.

At step 506, it is determined whether the communication link to the destination UE device is still above the minimum threshold for communication with the candidate relay device. For the example, the candidate relay device determines whether an updated neighbor list has been received from the destination UE device identified in the source transmission. In some situations, the candidate relay device may determine whether a recent discovery signal has been received from the destination UE device in determining whether the destination UE device meets the minimum threshold for communication. Where the source transmission is unicast, the determination of whether the minimum threshold has been met is typically performed during establishment of the PC5-RRC connection between the source UE device and the candidate relay device and is performed prior to receipt of the destination device data. In other cases, the reception of a discovery message from the relay UE may be used to determine whether the minimum threshold has been met. If the destination UE device is within communication range, the method continues at step 508. Otherwise, the method proceeds to step 510. Step 506 provides a mechanism for addressing a situation where the source UE device has not yet received an updated neighbor list from the candidate relay device when initiating the source transmission.

At step 510, a undeliverable feedback message is sent to the source UE device. In one example, the undeliverable feedback message is a PC5-RRC message indicating that the candidate relay device cannot deliver the destination device data. In other examples, the undeliverable feedback message indicates the reason the destination device data cannot be delivered and indicates that the destination UE device no longer meets the minimum link threshold. Although a NACK feedback message can be sent as the undeliverable feedback message in some circumstances, such feedback is less valuable to the source UE device since the source UE cannot determine from the NACK whether the source transmission was not received at the candidate relay device or the relay transmission failed.

At step 512, the neighbor list is updated to exclude the destination UE device that is no longer within communication range. At step 514, the neighbor list is broadcast at the next scheduled neighbor list broadcast time. The method returns to step 502 after the updated neighbor list is broadcasted. Although not shown in FIG. 5, the relay UE device sends an updated neighbor list including the destination UE device if the destination UE device returns to a situation where it is within communication range.

At step 508, it is determined whether communication data other than the destination device data is available for transmission. The other communication data may include direct communication data that is data that the candidate relay device is to transmit to another UE device as direct UE device to UE device communication. In other words, direct communication data is data related to the candidate relay device's own communication. For the examples of FIG. 5, the communication data may also include other destination device data that the candidate relay device has been requested to relay. In some situations, the candidate relay device may be functioning as a relay UE device for several source UE devices. If other communication data is available, the method continues at step 516. Otherwise, the method proceeds to step 518.

At step 516, the destination device data is transmitted in a relay transmission to the destination UE device. In some situations, the communication resources used for the relay transmission may be communication resources previously reserved by the candidate relay device. For example, the communication resources may have been reserved for transmission for direct communication data from the candidate relay device to another UE device. In other situations, the communication resources used for the relay transmission may have been reserved by the source UE device as discussed above with reference to FIG. 1B.

At step 518, it is determined whether the priority level of the destination device data is greater than the priority level of the other communication data. The priority levels are established for each of the data communications and the candidate relay device evaluates the priority levels. In accordance with NR V2X, QoS requirements in the physical (PHY) layer are indicated in the priority field in the first stage SCI (3 bits representing 8 QoS levels that maps to higher layers). Accordingly, at least one factor that may be applied to the different data includes the QoS level. The QoS levels, however, do not necessarily correspond to a one-to-one comparison by the candidate relay device where the highest QoS leads to the highest priority assignment. In one example, the serving base station (gNB) configures, UE devices (including candidate relay UE devices) to prioritize data based on whether the data is relayed data or direct communication data. Where direct communication data is prioritized, therefore, the candidate relay device assigns the direct communication data priority higher than data to be relayed. The base station may pre-configure the UE devices for situations where the UE device is Out-of Coverage (OoC).

In another example, the candidate relay device determines the data prioritization based on at least the QoS level provided by the source UE device for the destination device data. The assigned priority may be based on other factors and algorithms in addition to, or alternatively to the QoS level. Other factors for assigning a priority level to the different data includes the application type and the packet delay budget for the data. For example, a public safety application may be assigned highest priority.

In some situations, the candidate relay device informs the source UE device during the discovery procedure, or the relay reselection procedure, whether the candidate relay device has the capability to handle the relaying of high priority data. With such a technique, the source UE device applies the information to better select, or reselect, which the candidate relay device(s).

For the example, if the priority levels are the same, the candidate relay device determines that the destination device data priority level is not greater than the direct communication data priority level. If the destination device data priority level is greater than the direct communication data priority level, the method continues at step 519. Otherwise, the method proceeds to step 520.

At step 519, the destination device data is transmitted with a higher prioritization than the other data. As discussed below with reference to step 522, the other data may still be transmitted in accordance with a Prioritized Bit Rate (PBR) technique.

At step 520, the candidate relay device sends prioritization indication message to the source UE device that informs the source UE device that the destination device data has been prioritized lower than other data. In some situations, the prioritization indication message may indicate additional information regarding the prioritization and the other data. For example, the levels of priority of the other data and/or the amount of other data may be provided. In another situation, a NACK HARQ feedback to the source UE device may be transmitted as an alternative to the prioritization indication message. Such a technique may be advantageous when the priority of the destination device data is prioritized below a minimum threshold.

At step 522, the destination device data is transmitted with a lower priority. In accordance with known techniques, the candidate relay device assigns different Logical Channel ID (LCID) and applies Logical Channel Prioritization (LCP) in the MAC layer to determine which data gets transmitted next. Typically, the highest priority logical channel is served first in the MAC PDU, followed by data from the next highest priority logical channel, continuing until the MAC PDU space runs out. The absolute priority-based method sometimes leads to starvation of data from low-priority logical channels where the data from the low-priority logical channels cannot be transmitted because the data from high-priority logical channels takes up all the MAC PDU space. A Prioritized Bit Rate (PBR) is defined for each logical channel, in order to transmit data in order of importance but also to avoid starvation of data with lower priority. The PBR is the minimum data rate guaranteed for the logical channel. Even if the logical channel has low priority, at least a small amount of MAC PDU space is allocated to guarantee the PBR. Thus, the starvation problem can be avoided by using the PBR. Accordingly, the destination device data is still transmitted to the destination device but perhaps at lower than preferred rate or with more than acceptable delay. Accordingly, the transmission of the prioritization indication at step 520 allows the source UE device to evaluate the current relay devices and priority levels to determine whether relay reselection should be invoked.

In some situations, as an alternative to transmitting the destination device with a lower priority, the destination device data may not be transmitted by the candidate relay device when the priority level is lower than the priority of other data. In such situations, the prioritization indication at step 520 indicates that the destination device data will not be relayed.

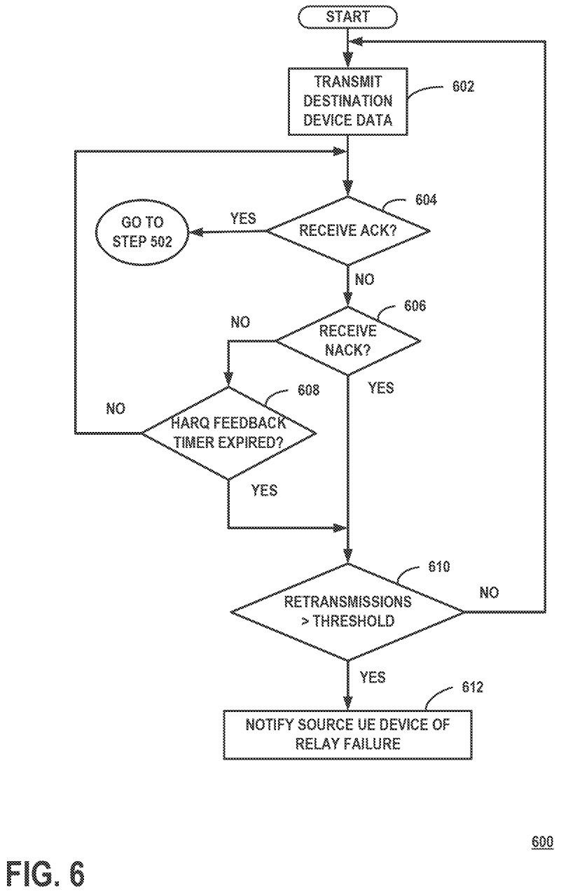

FIG. 6 is a flow chart of a method 600 of transmitting relay transmissions at a candidate relay device including retransmission. For the example, the method is performed by a UE device operating in system in accordance with at least one revision of the NR V2X specification, such as the system 100 described above. Accordingly, the method may be performed by the relay UE devices 103-105.

At step 602, the destination device data is transmitted to the destination UE device 102. The relay UE device transmits a relay transmission including the destination device data. In some situations, the communication resources used for the relay transmission may be communication resources previously reserved by the candidate relay device. For example, the communication resources may have been reserved for transmission for direct communication data from the relay UE device to another UE device. In other situations, the communication resources used for the relay transmission may have been reserved by the source UE device as discussed above with reference to FIG. 1B, A HARQ feedback timer is initiated at the time of the relay transmission. For the example, a retransmission counter is incremented after the transmission. Accordingly, after the initial transmission of the destination device data, the retransmission counter is established at “1” and increased after each retransmission of the same destination device data.

At step 604, it is determined whether an ACK HARQ feedback has been received from the destination UE device. If an ACK has been received, the method continues with normal operation. For the example, the method continues at step 502 for the example of FIG. 5. If an ACK is not received, the method proceeds to step 606 wherein it is determined whether a NACK HARQ feedback has been received. If NACK has not been received, the method continues at step 608. If NACK is received, the method continues to step 610.

In some situations, the relay UE device transmits a NACK immediately after receiving a NACK from the destination UE device. The source UE device can then take immediate action in response to the failed relay transmission. The source UE device, may notify the relay UE devices to perform retransmission, for example. In another example, the source UE device may immediately restart the relay process by evaluating neighbor lists and selecting candidate relay devices. Also, the relay UE device may send an ACK to the source UE device as an alternative to, or in addition to, continuing with normal operation in repose to receiving an ACK at step 604. As discussed below, in some situations where HARQ feedback includes ACK, the source UE device may take action in response to not receiving an ACK from the relay UE device within a threshold time period. For example, the source UE device may reserve communication resources for retransmission and instruct the relay UE devices to perform a retransmission. With one technique, the source UE device sends the reserved communication resources to the relay UE devices, but without destination data. With another technique, the source UE device instructs the relay UE device, using PC5-S messaging (groupcast case) or PC5-RRC signaling (unicast case), whether the relay UE should perform retransmission when a NACK is received from the destination UE device before the NACK is forwarded to the source UE device. In this case, the instruction is valid for the entire session of the groupcast or unicast connection until the source UE device alters the instruction to stop the autonomous retransmission at the relay UE devices. One advantage of such a scheme allows for retransmission before the HARQ timer expires.

At step 608, it is determined whether a HARQ feedback timer for the relay transmission has expired. If the timer has expired, the method continues at step 610. Otherwise, the method returns to step 604.

At step 610, it is determined whether the retransmission counter has exceeded a threshold. If the number of retransmissions of the destination device data is greater than the threshold, the method continues to step 612. Otherwise, the method returns to step 602 where the destination device data is retransmitted, the retransmission counter is incremented, and the HARQ feedback timer is reset. In some cases, the number of retransmissions may be configurable and may vary depending on the QoS of the communication service.

At step 612, the source UE device is notified that the relay transmission to the destination UE device has failed. For the example, the relay UE device sends a message to inform the source UE device via PC5-RRC link or the PC5-S layer. As is known, the PC5 signaling (PC5-S) layer in upper layer that is located on top of the Packet Data Convergence Protocol (PDCP), Radio Link Control (RLC) and Medium Access Control (MAC) sublayers as well as the physical layer for the control plane in the PC5 interface. As discussed below, the source UE device may reevaluate the neighbor lists and restart the relay process including performing a selection of candidate relay devices.

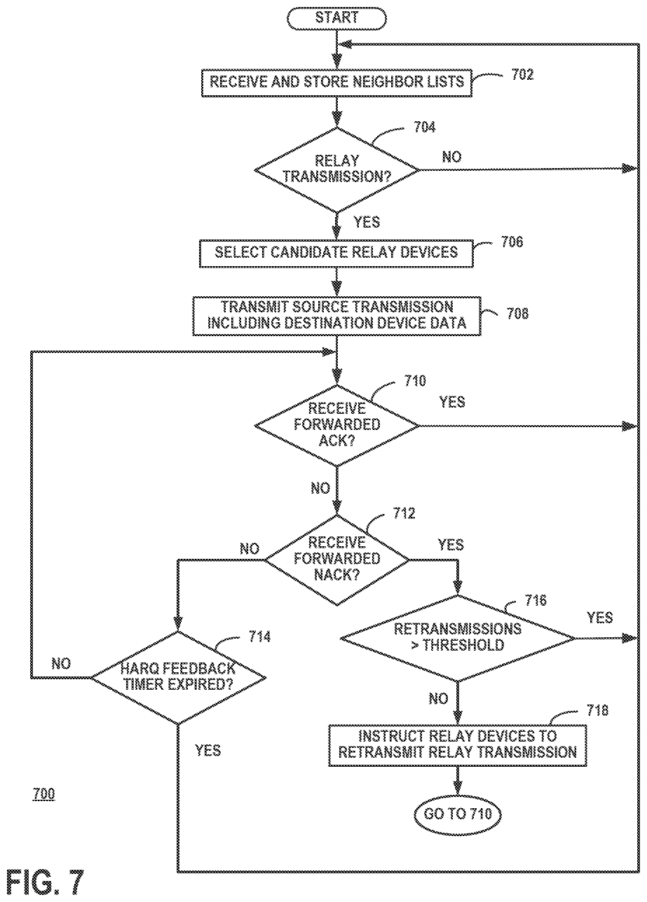

FIG. 7 is a flow chart of an example of a method 700 of managing relay transmissions at a source UE device. For the example, the method is performed by a UE device operating in system in accordance with at least one revision of the NR V2X specification, such as the system 100 described above. Accordingly, the method may be performed by the source UE device 101.

At step 702, neighbor lists from nearby UE devices are received and stored. In accordance with known techniques, the source UE device receives neighbor lists from UE devices where each list identifies neighbor UE devices of the UE device transmitting the neighbor list as well as the neighbor UE devices of the listed neighbor devices. The information of each list is stored in memory and is revised when updated neighbor lists are received. As discussed below in further detail, the neighbor lists may include information indicating link quality for each neighbor UE device in some situations.

At step 704, it is determined whether a relay transmission is pending. The source UE device determines whether destination device data that should be transmitted to a destination UE device using a relay UE device. If there is no transmission available for potential relay communication, the method returns to step 702 where the neighbor lists are received and updated. The UE device may continue with direct UE device to UE device communication and/or communication with base stations. If a transmission via relay UE device is available, the method continues at step 706.

At step 706, candidate relay devices are selected. The source UE device selects at least one candidate relay device, and may select a plurality of candidate relay devices, based on the information in the neighbor lists. In some situations, the selection of a candidate relay device may be based on simply the inclusion of the destination device in the neighbor list of the UE device providing the neighbor list. In other situations, the selection may be based on additional criteria. For example, as discussed below, the section may be based on the quality of the communication link between the potential candidate relay device and the destination device.

At step 708, the source transmission including the destination device data is transmitted to the candidate relay device(s). Where multiple candidate relay devices have been selected, the source transmission is sent via broadcast in the example. In some situations, unicast may be used for the source transmission. For the example, the source transmission includes an indicator that indicates that the candidate relay device is to forward the destination device data to the destination device. In some situations, the indicator may also reserve a communication resource for the transmission of the destination device data from the candidate relay device. In some examples, as discussed above, the source UE device also sends a communication resource reservation to reserve a communication resource for transmission of the relay transmission from the candidate relay devices to the destination UE device. In other examples, the source transmission includes a request to transmit the relay transmission using a communication resource received by the candidate relay device for its own transmission. As discussed above, the relay indicator may be part of the unicast connection establishment procedure where multiple unicast links are used with multiple candidate relay devices.

At step 710, it is determined whether a forwarded ACK has been received. In examples where ACK/NACK HARQ feedback from the destination device to the relay UE device is forwarded by the relay UE device to the source UE device, the source UE device receives the forwarded ACK when the destination UE device has successfully received the destination device data in the relay transmission. If a forwarded ACK is received, the method returns to step 702. Otherwise, the method continues at step 712.

At step 712, it is determined whether a forwarded NACK has been received. In examples where NACK HARQ feedback from the destination device to the relay UE device is forwarded by the relay UE device to the source UE device, the source UE device receives the forwarded NACK when the destination UE device has not successfully received the destination device data in the relay transmission. If a forwarded NACK is not received, the method continues at step 714. Otherwise, the method continues at step 716.

At step 714, it is determined whether a HARQ feedback timer for the source transmission has expired. If the timer has not expired, the method returns to step 710. If the timer has expired, the method returns to step 702 to restart the process. Updated neighbor list information is applied to select the candidate relay devices which may be different than those selected previously.

At step 716, it is determined whether a retransmission counter has exceeded a threshold. If the number of retransmissions of the destination device data is greater than the threshold, the method returns to step 702 to restart the process. Otherwise, the method continues to step 718 where the relay UE devices are instructed to retransmit the destination device data before returning to step 710 to monitor HARQ feedback for the new transmission. The retransmission counter is incremented and the HARQ feedback timer is reset.

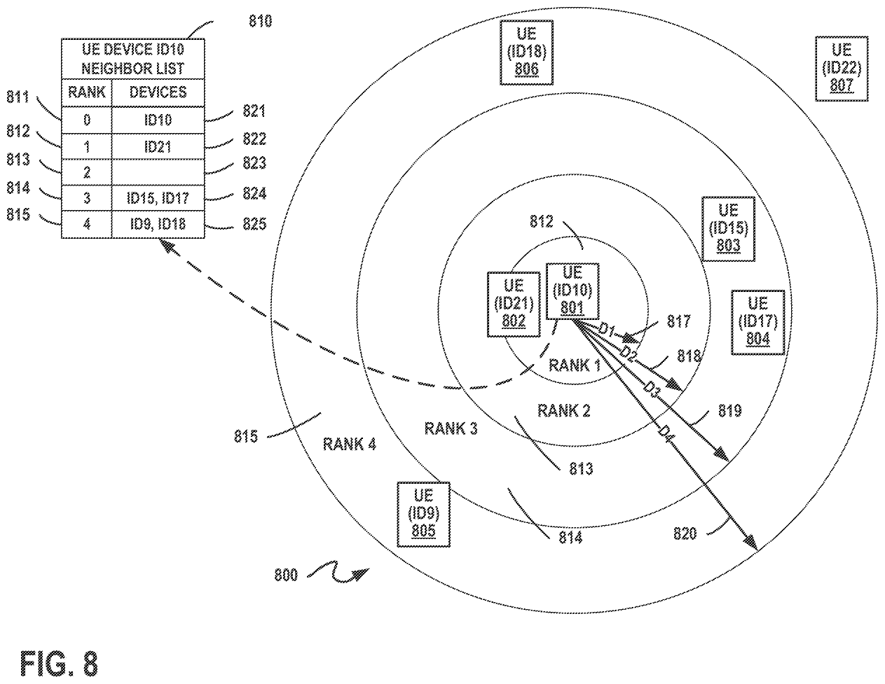

FIG. 8 is a block diagram of an example of a geographical arrangement 800 of UE devices 801-807 and a corresponding neighbor list 810 including link quality information associated with the arrangement 800. For the example, the neighbor list 810 is provided by a first UE device 801 having a unique identification of “ID10”. The neighbor list 810 includes a plurality of rankings 811-815 where each ranking is associated with a range of received signal strengths of signals received from UE devices. The signals received and measured at the first UE device 801 may be discovery signals or neighbor list signals conveying neighbor lists from nearby UE devices 102-107. Other signals may be used in some circumstances. In some situations, the rank is based directly on the geographical location of the UE devices. In one scenario, for example, the UE devices share their locations with the other nearby UE devices and the neighbor lists are generated based on the distances between the locations.

Since the received signal strength of a signal is at least somewhat dependent on the distance to the transmitter that is transmitting the signals, the rankings are at least partially related to the distance between the first UE device and the UE device transmitting the signal. The received signal strength is also related to the quality of the communication link between the transmitting UE device and the first UE device. Therefore, each of the plurality of rankings also indicates a quality of the communication link between the first UE device 801 and a UE device associated with a particular rank. In other words, UE devices associated with a ranking are expected to have a communication link to the first UE device that has a quality level associated with that ranking. The rankings are organized such that a lower ranking indicates a higher quality communication link. Rank 1 represents a better quality communication link (shorter distance) than rank 2.

For the example, the rankings are associated with the distances 817-820 between the UE devices 802-807 and the first UE device 801. In FIG. 8, the region between the largest circle representing the longest distance 820 and the second largest circle representing the second longest distance 819 is associated with rank 4 815. The region between the second largest circle representing the second longest distance 819 and the third largest circle representing the third longest distance 818 is associated with rank 3 814. The region between the smallest circle representing the shortest distance 817 and the next largest circle representing the next longest distance 818 is associated with rank 2 813. The region within the smallest circle is associated with the rank 1 812. Although in the example, the rankings are associated with the distances between the UE devices 802-807 and the first UE device 801, in some situations, the ranking of a UE device may not correspond to the distance between the UE device and the first UE device. This may occur where the communication path between the two UE devices is obstructed, for example. The rankings, however, still provide an indication of the quality of the communication links. Accordingly, techniques described herein are based on selecting relay devices based on the quality of communication links where one factor in determining the quality of a link can be based on distance. As mentioned above, the distance may be determined by the UE devices exchanging information regarding their locations. However, the distance is an indirect mechanism for ranking the quality of the link and, in some situations, techniques that more directly determine link quality for ranking may be used.

The neighbor list 810 includes information that identifies the neighbor devices of the first UE device and associates a ranking to each UE device. Although the information may be represented in any format or structure, FIG. 8 shows the information in tabular form where each rank 811-815 uniquely corresponds to a UE device set of a plurality of UE device sets 821-825. For the example, the first UE device 801 is associated with rank 0. Accordingly, the identification of the first UE device, ID10, is listed in the UE device set 821 associated with rank 0 811. The identification of the second UE device, ID21, is listed in the UE device set 822 associated with rank 1 812. No UE device ID is included in the UE device set 823 associated with rank 2 813 since no neighbor UE device is within the region of rank 2 823. Continuing with the example, the UE device identifiers, ID15, ID17, of the third UE device 803 and the fourth UE device 804 are included in the UE device set 824 associated with rank 3 814 and the UE device identifiers, ID9, ID18, of the fifth UE device 805 and the sixth UE device 806 are included in the UE device set 825 associated with rank 4 815. The UE device identifier, ID22, is not included in the neighbor list since it is outside the lowest quality ranking, rank 4 815.

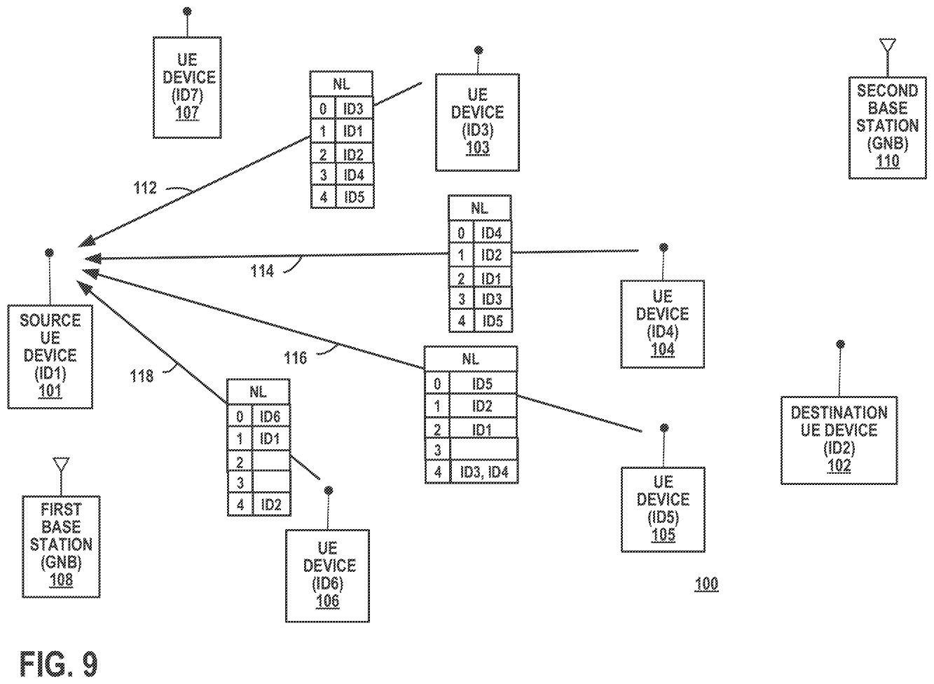

FIG. 9 is block diagram of the system 100 for an example the neighbor lists 112, 114, 116, 118 include communication link quality information. The neighbor lists in the example of FIG. 9, therefore, are examples of the neighbor list 810 discussed with reference to FIG. 8. The operation of the system 100 is the same as operation of the system 100 discussed above except for aspects related to the neighbor lists, candidate relay selection, and signal modulation and coding management based on the link quality information.

For the example of FIG. 9, neighbor lists 112, 114, 116, 118 from four UE devices 103-106 are received at the source UE device 101. Each neighbor list includes identifiers of UE devices associated with a ranking. For the example, the identifier (ID2) of the destination UE device 102 is included in each of the four neighbor lists where the identifier is associated with rank 2 in the neighbor list 112 from the UE device 103, rank 1 in the neighbor lists 114, 116 from the UE devices 104, 105, and rank 4 in the neighbor list 118 from the UE device 106. The source UE device 101 evaluates the list and selects the candidate relay devices based on the ranking of the identifier (ID2) of the destination UE device 102. In one scenario, the source UE device 101 selects three candidate relays devices 103-105 including the UE devices 103 with a rank of 2 and the UE devices 104, 105 with a rank of 1 for ID2. In another scenario, the source UE device 101 only selects the UE devices 104, 105 having a rank of 1 for ID2. Although the UE device 106 includes ID2 as rank 4, the source may select the UE device 106 as a candidate relay device in some situations.

In another example, the source UE device 101 selects the candidate relays devices further based on the quality of the communication link between the source UE device 101 and the potential candidate relay device. A suitable technique includes selecting a candidate relay device based on the sum of the ranks of the destination UE device and the source UE device listed in the neighbor lists. The potential candidate device having the lower total rank sum is more selected over those having higher total rank sums. Applying the scenario depicted in FIG. 9, for example, the sum of ranks for UE device 103 is the rank of ID1 (1) and the rank of ID 2 (2) which is equal to 3. The sum of ranks for UE device 104 is the rank of ID1 (2) and the rank of ID 2 (1) which is also equal to 3. Therefore, even though the destination UE device has a higher rank (e.g., rank 1) in the neighbor list 114 for the UE device 104, the selection of candidate devices may include both the UE device 103 and the UE device 104.

In some situations, the source UE device 101 may select a single candidate relay device with the lowest rank or lowest total path rank. In other situations, the source UE device 101 may select a set of candidate relay devices that have the same total path rank. For the situation of FIG. 9, for example, the source UE device 101 selects the UE devices 103-105 as the candidate relay devices since all three have the total path rank of 3 which is the lowest of the potential candidate relay devices 103-106. In other examples, the source UE device 101 selects a set of candidate relay devices that have a total path rank less than a threshold but may have different total path ranks. In such a situation the UE device 106 may be selected in addition to the UE devices 103-105 even though the total path rank for the UE device 106 is 5.

In addition to providing criteria for selecting the potential candidate relay devices, the neighbor lists with link quality information may provide criteria for managing modulation and coding of the source transmission and the relay transmission. In one example, the source UE device 101 selects a modulation coding scheme (MCS) based on the neighbor list. Since the rank of a UE device is a function of the link quality between UE devices, the MCS can be based at least partially on the rank of the UE device in the neighbor list. For the examples, the source UE device 101 applies more robust MCS to lower ranks.

In one example, the source UE device selects the MCS based on the lowest rank of the destination UE device appearing in a neighbor list of the candidate relay devices. In the scenario of FIG. 9, therefore, the MCS is based on rank 1 since the destination UE device has rank 1 in the neighbor lists 114, 116. Such a technique may be advantageous where the relay UE devices apply the same MCS used in the source transmission to the relay transmission.

In another example, the source UE device 101 selects a different MCS for the relay transmission from the MCS of the source transmission. Such a technique may be more efficient than using the same MCS for both transmissions. The source UE device 101 indicates the MCS in the control information of the source transmission that is to be applied to the relay transmission. The selection of the MCS for the relay transmission is at least partially based on the lowest rank assigned to the destination device in a neighbor list. More robust MCS is selected for lower ranks and less robust MCS is selected for higher ranks. In some situations, the MCS for the source transmission is at least partially based on the rank of the identification of the source UE device 101 in the neighbor list of the candidate relay device.

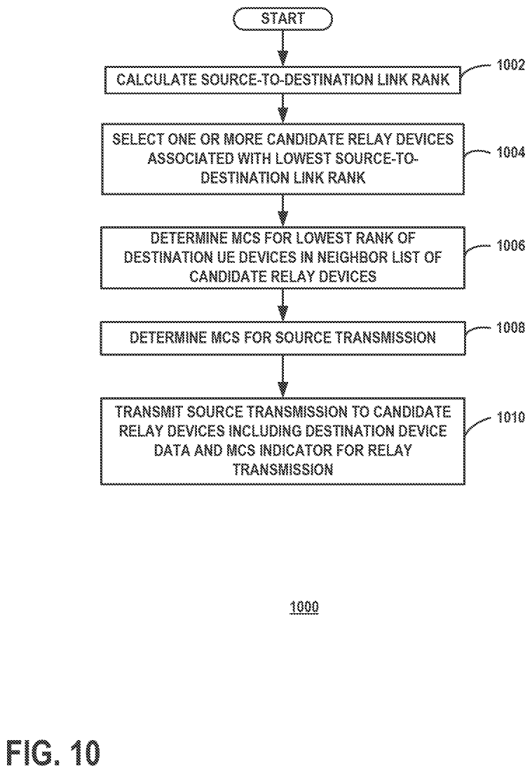

FIG. 10 is a flow chart of an example of a method 1000, performed at a source UE device, of selecting candidate relay devices based on neighbor lists with ranks. For the example, the method is performed by a UE device operating in system in accordance with at least one revision of the NR V2X specification, such as the system 100 described above. Accordingly, the method may be performed by the source UE device 101. The example of FIG. 10 may be performed as part of the example discussed above with reference to FIG. 7. For example, steps 1002, 1004, 1006, and 1008 may be performed as part of step 706 and step 1010 is an example of performing step 708. Although the example discusses relay selection based on neighbor lists and rankings, in some situations, the selection is based on other criteria. Examples of other criteria may include upper layer criteria such as relay policy, security, and supported application criteria where some applications are authorized by the network and not all relay UE devices may be able to support the intended application. Therefore, the example discussed herein may be performed in conjunction with other selection mechanisms.

Also, in some situations, the final determination of the candidate relay devices that may perform the function of a relay UE device may include the involvement from the destination UE device. For example, in some scenarios, the source UE may select a few candidate relay devices, the candidate relay devices inform the destination UE device regarding the request from the source UE, and the destination UE device finalizes selection of which device to use as a relay among the candidate relay devices selected by the source UE device. As a result, in some circumstances, the example of FIG. 10 may include additional steps that are not shown in FIG. 10 where these steps involve actions, feedback or other intervention by the destination UE device.

At step 1002, a source-to-destination link rank is calculated. For each neighbor list, the source UE device calculates the sum of the rank of the destination UE device and the rank of the source UE device.

At step 1004, at least one candidate relay device is selected at least partially based on the calculated source-to-destination link ranks. For the example, the UE devices with neighbor lists having the lowest rank sums are preferred candidates and selected. In some situations, only the UE devices with lowest rank sum are selected. In other situations, the UE devices with lowest rank sum are selected as well as other UE devices that have low rank sum values even though those values are not the lowest.

At step 1006, the destination MCS for the relay transmission is selected at least partially based on the rank values of the destination UE device 102. For the example, the lowest rank (best link) is used to determine the destination MCS. Therefore, where more than one candidate relay device is selected, the source UE device evaluates the neighbor lists of the selected candidate relay device to identify the lowest rank associated with the ID of the destination UE device to determine the MCS for the relay transmission.

At step, 1008, the source MCS of the source transmission is determined. In one example, the source MCS for the source transmission is the same as the destination MCS for the relay transmission. In other examples, the source MCS is different than the destination MCS. With one technique, the source MCS and the relay MCS are determined at least partially based on the highest rank (lowest quality) of the communication links of all the S-R links associated with the ID of the source UE device. For such an example, therefore, where multiple relay UE devices are selected, the highest rank S-R communication link determines the source MCS for the source transmission and the highest rank R-D communication link determines the relay MCS for the relay transmissions. Accordingly, the most robust MSC dictated by the lowest quality link is used for each segment of the relay path, respectively.

The management of MCS is at least somewhat dependent on the particular cast type and communication resource scenario in the examples. For the examples involving multiple candidate relay devices discussed below, each segment of the relay path (S-R link and R-D link) may be either be unicast or broadcast with relay indication information.

Where the source transmission is broadcast with relay identifying information and the relay transmissions are broadcast with destination device identifying information, source MSC may be the same for the two path segments or the source MCS may be different from the relay MCS. Where the source MCS is the same as relay MCS, the MCS is selected, in one example, based on the highest rank (lowest quality) link which can be either an S-R link or R-D link. In one MCS management technique, where the source MCS is different from the relay MCS, the source MCS is based on the highest rank (lowest quality) S-R link of all of the S-R links for the relays that were selected and the relay MCS is based on the highest rank (lowest quality) R-D link of all of the R-D links for the relays that were selected.

In some other scenarios where the source transmission is multiple unicast transmissions (one to each selected relay device) on different communication resources and relay transmission is broadcast with destination device identifying information source MCS for each source unicast transmission can be different from the other source unicast transmissions. Each source MCS is based on the quality of the specific link to the relay UE device. A single relay MSC can be used for all of the R-D links of the selected relay devices and is selected based on the highest rank (lowest quality) R-D link.

In some scenarios where the source transmission consists of multiple unicast transmissions (one to each selected relay device) on the same communication resource, unicast is established with each selected relay but the source transmission of destination data is over the same resource (radio bearer) to the selected relay UE devices and the relay transmission consists of multiple unicast transmissions (from each selected relay device to the destination device) on the same communication resource. The unicast connections are established from each selected relay to the destination device but the relay transmissions of destination data are over the same resource (radio bearer) to the selected destination UE device. For such scenarios, where the source MCS is the same as the relay MCS, the MCS is selected based on the highest rank (lowest quality) link which can be either an S-R link or R-D link. Where the source MCS is different from the relay MCS, the source MCS is based on the highest rank (lowest quality) S-R link of all of the S-R links for the relays that were selected and the relay MCS is based on the highest rank (lowest quality) R-D link of all of the R-D links for the relays that were selected.

At step 1010, the source transmission is transmitted to the candidate relay device(s). The source transmission includes the destination device data and control information as discussed above. In some situations, the source transmission also includes control information identifying the destination MCS that should be used for the relay transmission. In implementations where the relay UE device applies the same MCS to the relay transmission as was used for transmitting the source transmission, the control information identifying the destination MCS is omitted. In situations where the source MCS and the destination MCS are different, the control information identified the destination MCS.

Clearly, other embodiments and modifications of this invention will occur readily to those of ordinary skill in the art in view of these teachings. The above description is illustrative and not restrictive. This invention is to be limited only by the following claims, which include all such embodiments and modifications when viewed in conjunction with the above specification and accompanying drawings. The scope of the invention should, therefore, be determined not with reference to the above description, but instead should be determined with reference to the appended claims along with their full scope of equivalents.

1. A relay user equipment (UE) device comprising:
a receiver configured to receive, from a source UE device, destination device data and a relay indicator indicating that the destination device data is to be transmitted to a destination UE device;
a controller configured to determine whether other communication data is pending transmission to another UE device over a device-to-device communication link and, if other communication data is pending transmission, to determine whether a destination data priority level of the destination device data is greater than another data priority level of the other communication data; and
a transmitter configured to:
transmit the destination device data to the destination UE device when no other communication data is pending transmission,
transmit the destination device data at a higher priority than the other communication data when the destination data priority level is greater than the direct data priority level, and
transmit the other communication data at a higher priority that the destination device data when the destination data priority level is not greater than the another data priority level.

2. The relay UE device of claim 1, wherein the transmitter applies Logical Channel Prioritization (LCP) in the MAC layer to prioritize transmission of data.

3. The relay UE device of claim 1, wherein the other communication data is direct communication data only between the relay UE device and the another UE device.

4. The relay UE device of claim 1, wherein the other communication data is other destination device data communication that the relay UE device has been requested to relay to another destination UE device.

5. The relay UE device of claim 1, wherein each of the destination data priority level and the direct data priority level is based on at least one of a (quality of service) QoS level, application type, packet delay budget and a relay-direct priority configuration indicating which type of data is to be transmitted.

6. The relay UE device of claim 1, wherein the transmitter is configured to transmit prioritization indication message to the source UE device if the destination data priority level is not greater than the another data priority level.

7. The relay UE device of claim 1, wherein the controller is further configured to determine whether the destination UE device is within communication range of the relay UE device, the transmitter configured to transmit a non-acknowledgement (NACK) hybrid automatic repeat request (HARQ) message to the source UE device when the destination UE device is not within communication range of the relay UE device.

8. The relay UE device of claim 1, wherein the controller is further configured to determine whether the destination UE device is within communication range of the relay UE device, the transmitter configured to transmit a PC5 message to the source UE device indicating the destination UE device is not within communication range of the relay UE device.

9. The relay UE device of claim 1, wherein the controller is configured to generate a neighbor list comprising a plurality of device identifiers, each device identifier uniquely identifying one of a plurality of proximate UE devices meeting a minimum communication link threshold to the relay UE device, the destination UE device identified by one of the device identifiers,
the transmitter configured to broadcast the neighbor list prior to receipt of the source transmission.

10. The relay UE device of claim 9, wherein the controller is further configured to determine whether the destination UE device meets a minimum communication link threshold to the relay UE device and configured to generate an updated neighbor list omitting the device identifier identifying the destination UE device if the destination UE device does not meet the minimum communication link threshold to the relay UE device,
the transmitter configured to broadcast the updated neighbor list at a next scheduled neighbor list broadcast time.

11. The relay UE device of claim 1, wherein the receiver is configured to receive hybrid automatic repeat request (HARQ) feedback from the destination device after transmission of the relay transmission, the transmitter configured to retransmit the relay transmission when the receiver receives HARQ feedback comprising a non-acknowledgement (NACK) message.

12. The relay UE device of claim 11, wherein the transmitter is configured to transmit a failure notification to the source UE device, the failure notification indicating that the destination device data was unsuccessfully received at the destination UE device.

13. The relay UE device of claim 12, wherein the transmitter is configured to transmit the failure notification to the source UE device when a number of retransmissions of the destination device data exceeds a threshold.

14. The relay UE device of claim 12, wherein the transmitter is configured to transmit the failure notification to the source UE device when a HARQ feedback timer for the destination device data as expired.

15. The relay UE device of claim 12, wherein the failure notification comprises a relay device NACK message.

16. The relay UE device of claim 12, wherein the failure notification is transmitted via at least one of a PC5-RRC message and a PC5-S message.

17. The relay UE device of claim 1, the receiver further configured to receive a retransmission instruction from the source UE device, the transmitter further configured to retransmit the relay transmission in response to the retransmission instruction.

18. A source user equipment (UE) device comprising:
a receiver configured to receive, a neighbor list from each of a plurality of neighbor UE devices, each neighbor list identifying proximate UE devices that are within communication range of the neighbor UE device transmitting the neighbor list;
a controller configured to select, from the plurality of neighbor UE devices and based at least partially on the neighbor lists, at least one candidate relay device for relaying destination device data to a destination UE device; and
a transmitter configured to transmit the destination device data and a relay indicator to the at least one candidate relay device, the relay indicator indicating that the at least one candidate device is to transmit the destination device data to the destination UE device, the controller configured to transmit a retransmission instruction instructing the at least one candidate relay device to retransmit the destination device data.

19. The source UE device of claim 18, wherein the transmitter is further configured to transmit a communication resource reservation indicator identifying a communication resource for retransmission of the destination device data from the at least one candidate relay device to the destination UE device and indicating to the at least one candidate relay device that the communication resource is for retransmission of the destination device data and indicating to other UE devices receiving the communication resource reservation indicator that the communication resource has been reserved.

20. The source UE device of claim 18, wherein the transmitter is configured to transmit a communication resource reservation indicator in response to receiving a non-acknowledgement (NACK) hybrid automatic repeat request (HARQ) message from the at least one candidate relay device.

21. The source UE device of claim 20, wherein the NACK HARQ message is a forwarded NACK HARQ message transmitted by the destination UE device.
